(19) United States
(12) Patent Application Publication
(10) Pub. No.: US 2023/0364476 A1
(43) Pub. Date: Nov. 16, 2023

(54) GOLF BALL RUBBER COMPOSITION AND GOLF BALL USING THE SAME

(71) Applicant: Sumitomo Rubber Industries, Ltd., Kobe-shi (JP)

(72) Inventors: Hikaru NAGAKURA, Kobe-shi (JP); Kazuyoshi SHIGA, Kobe-shi (JP); Kai HAYASHI, Kobe-shi (JP)

(73) Assignee: Sumitomo Rubber Industries, Ltd., Kobe-shi (JP)

(21) Appl. No.: 18/144,974

(22) Filed: May 9, 2023

(30) Foreign Application Priority Data
May 10, 2022 (JP) 2022-077660

(51) Int. Cl. A63B 37/00

(52) U.S. Cl. CPC A63B 37/0051; A63B 37/0066; A63B 37/00622

(57) ABSTRACT

An object of the present disclosure is to provide a cured product of a golf ball rubber composition imparting excellent durability to a golf ball. The present disclosure provides a cured product of a golf ball rubber composition containing (a) a base rubber, (b) an α,β-unsaturated carboxylic acid having 3 to 8 carbon atoms and/or a metal salt thereof as a co-crosslinking agent, and (c) a crosslinking initiator, wherein an effective crosslinking density DC (mmol/cm³) of the cured product and a tensile modulus TM of the cured product at a strain (MPa) from 0.05% to 0.25% satisfy a relationship of TM−333.32×ln(DC)>100.

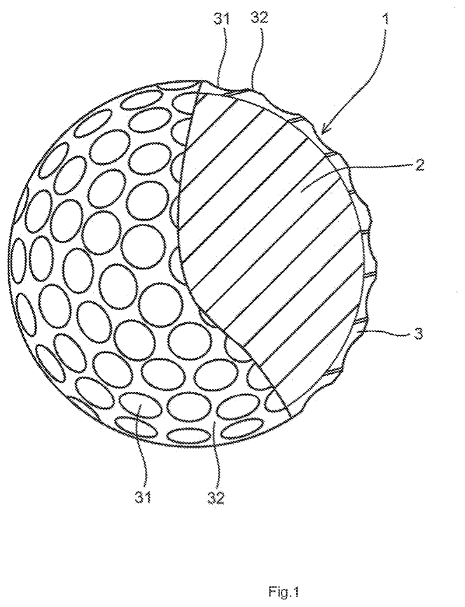

### FIELD OF THE INVENTION

The present disclosure relates to a golf ball rubber composition.

### DESCRIPTION OF THE RELATED ART

As a material for forming a core of a golf ball, a rubber composition containing a base rubber, a co-crosslinking agent and a crosslinking initiator is widely used in light of its good resilience. In addition, it has been proposed to control a crosslinking density of a core formed from such rubber composition.

For example, JP 2021-090715 A discloses a cured product of a golf ball rubber composition containing (a) a base rubber, (b) an α,β-unsaturated carboxylic acid having 3 to 8 carbon atoms and/or a metal salt thereof as a co-crosslinking agent, and (c) a crosslinking initiator, wherein an effective crosslinking density DC (mmol/cm³) of the cured product and a tensile modulus TM (MPa) of the cured product at a strain from 0.05% to 0.25% satisfy a relationship of the mathematical formula (1): TM−3.33×ln(DC)>(−0.10) . . . (1).

JP 2020-185067 A discloses a golf ball comprising a core and at least one cover layer covering the core, wherein the core is formed from a core rubber composition containing (a) a base rubber, (b) an α,β-unsaturated carboxylic acid having 3 to 8 carbon atoms and/or a metal salt thereof as a co-crosslinking agent, (c) a crosslinking initiator, and (d) a hindered phenol compound, and (b) the co-crosslinking agent and (d) the hindered phenol compound are blended in the core rubber composition such that the following formula (1) is satisfied,

0.04≤HF/B≤0.35 (1)

in the formula (1), HF=a number of OH functional group in one molecule of (d) the hindered phenol compound×an amount (mole) of (d) the hindered phenol compound with respect to 100 parts by mass of (a) the base rubber, and B=an amount (mole) of (b) the co-crosslinking agent with respect to 100 parts by mass of (a) the base rubber.

JP 2020-196868 A discloses a cured product of a golf ball rubber composition containing (a) a base rubber, (b) an α,β-unsaturated carboxylic acid having 3 to 8 carbon atoms and/or a metal salt thereof as a co-crosslinking agent, and (c) a crosslinking initiator, wherein the cured product of the golf ball rubber composition satisfies the following mathematical formula (1):

Y<0.1×X−1.30 (1),

in the formula (1), Y represents an effective crosslinking density of the cured product of the rubber composition (mmol/cc), and X represents an amount (parts by mass) of the component (b) with respect to 100 parts by mass of (a) the base rubber.

JP 2021-137300 A discloses a cured product of a golf ball rubber composition containing (a) a base rubber, (b) an α,β-unsaturated carboxylic acid having 3 to 8 carbon atoms and/or a metal salt thereof as a co-crosslinking agent, and (c) a crosslinking initiator, wherein a product (hardness×(tan δ₋₈₀−tan δ₀)) obtained by multiplying a slab hardness of the cured product of the golf ball rubber composition in Shore C hardness by a difference (tan δ₋₈₀×tan δ₀) between a loss tangent of the cured product of the golf ball rubber composition at a temperature of −80° C. (tan δ₋₈₀) and a loss tangent of the cured product of the golf ball rubber composition at a temperature of 0° C. (tan δ₀) is 28.0 or more.

JP H07-108321 A discloses a solid golf ball comprising an elastic portion as at least a part thereof, wherein the elastic portion is formed from a rubber composition containing a base rubber, a metal salt of an α,β-ethylenically unsaturated carboxylic acid, an ethylenically unsaturated carboxylic acid ester having a hindered phenolic group, and a peroxide.

### SUMMARY OF THE INVENTION

An object of the present disclosure is to provide a cured product of a golf ball rubber composition imparting excellent durability to a golf ball without lowering shot feeling of the golf ball. Another object of the present disclosure is to provide a golf ball having excellent durability while having maintained good shot feeling.

The present disclosure that has solved the above problem provides a cured product of a golf ball rubber composition containing (a) a base rubber, (b) an α,β-unsaturated carboxylic acid having 3 to 8 carbon atoms and/or a metal salt thereof as a co-crosslinking agent, and (c) a crosslinking initiator, wherein an effective crosslinking density DC (mmol/cm³) of the cured product and a tensile modulus TM (MPa) of the cured product at a strain from 0.05% to 0.25% satisfy a relationship of the mathematical formula (1):

TM−333.32×ln(DC)>100 (1).

According to the present disclosure, a cured product of a golf ball rubber composition imparting excellent durability to a golf ball without lowering shot feeling of the golf ball is obtained. Further, according to the present disclosure, a golf ball having excellent durability while having maintained good shot feeling is obtained.

### BRIEF DESCRIPTION OF THE DRAWINGS

The FIGURE is a partially cutaway cross-sectional view showing a golf ball according to one embodiment of the present disclosure.

### DESCRIPTION OF THE PREFERRED EMBODIMENT

The present disclosure provides a cured product of a golf ball rubber composition containing (a) a base rubber, (b) an α,β-unsaturated carboxylic acid having 3 to 8 carbon atoms and/or a metal salt thereof as a co-crosslinking agent, and (c) a crosslinking initiator, wherein a natural logarithm value (In(DC)) of an effective crosslinking density DC (mmol/cm³) of the cured product of the golf ball rubber composition and a tensile modulus TM (MPa) of the cured product of the golf ball rubber composition at a strain from 0.05% to 0.25% satisfy a relationship of the mathematical formula (1): TM−333.32×ln(DC)>100 . . . (1).

In other words, the value (TM−333.32×ln(DC)) is more than 100. If the above relationship between the tensile modulus TM and the effective crosslinking density DC is satisfied, the obtained golf ball has improved durability. From this viewpoint, the value (TM−333.32×ln(DC)) is preferably 105 or more, more preferably 110 or more, and even more preferably 120 or more, and is preferably 500 or less, more preferably 480 or less, and even more preferably 450 or less.

The tensile modulus TM is preferably 50 MPa or more, more preferably 60 MPa or more, and even more preferably 70 MPa or more, and is preferably 310 MPa or less, more preferably 300 MPa or less, and even more preferably 290 MPa or less. If the tensile modulus TM is 50 MPa or more, the rubber composition is not excessively soft and thus the resilience is better, and if the tensile modulus TM is 310 MPa or less, the rubber composition is not excessively hard and thus the shot feeling is better. The tensile modulus is a value obtained by dividing the tensile stress by the tensile strain.

The effective crosslinking density DC is preferably 0.4 mmol/cm³ or more, more preferably 1.0 mmol/cm³ or more, and even more preferably 1.3 mmol/cm³ or more, and is preferably 8.0 or less, more preferably 4.0 mmol/cm³ or less, and even more preferably 2.0 mmol/cm³ or less. If the effective crosslinking density DC is 0.4 mmol/cm³ or more, the rubber composition is not excessively soft and thus the resilience is better, and if the effective crosslinking density DC is 8.0 mmol/cm³ or less, the rubber composition is not excessively hard and thus the shot feeling is better.

The cured product for measuring the tensile modulus and effective crosslinking density is in a state that vulcanization is almost completed (a state that the crosslinking density becomes maximum). Specifically, the cured product for measuring the tensile modulus and effective crosslinking density is a cured product of the rubber composition vulcanized at a temperature in a range from one-minute half-life temperature −10° C. to one-minute half-life temperature+10° C. of the crosslinking initiator for at least 30 minutes.

Next, the materials contained in the golf ball rubber composition will be explained.

### [(a) Base Rubber]

As (a) the base rubber, a natural rubber and/or a synthetic rubber can be used. For example, a polybutadiene rubber, a natural rubber, a polyisoprene rubber, a styrene polybutadiene rubber, or an ethylene-propylene-diene rubber (EPDM) can be used. These rubbers may be used solely, or at least two of these rubbers may be used in combination. Among them, the polybutadiene rubber or polyisoprene rubber is preferable, and a high cis-polybutadiene and/or high cis-polyisoprene having a cis-1,4 bond in an amount of 40 mass % or more, preferably 80 mass % or more, more preferably 90 mass % or more, and even more preferably 95 mass % or more in view of their superior resilience is particularly preferable.

From the viewpoint of obtaining a core having higher resilience, the amount of the high-cis polybutadiene in the base rubber is preferably 60 mass % or more, more preferably 80 mass % or more, and even more preferably 90 mass % or more. It is also preferable that (a) the base rubber consists of the high-cis polybutadiene.

The high-cis polybutadiene preferably has a 1,2-vinyl bond in an amount of 2.0 mass % or less, more preferably 1.7 mass % or less, and even more preferably 1.5 mass % or less. If the amount of the 1,2-vinyl bond is excessively high, the resilience may be lowered.

The high-cis polybutadiene is preferably a polybutadiene synthesized using a rare earth element catalyst. When a neodymium catalyst, which employs a neodymium compound that is a lanthanum series rare earth element compound, is used, a polybutadiene rubber having a high content of a cis-1,4 bond and a low content of a 1,2-vinyl bond is obtained with excellent polymerization activity. Such a polybutadiene rubber is particularly preferred.

The high-cis polybutadiene preferably has a Mooney viscosity (ML₁₊₄ (100° C.)) of 30 or more, more preferably 32 or more, even more preferably 35 or more, and preferably has a Mooney viscosity (ML₁₊₄ (100° C.)) of 140 or less, more preferably 120 or less, even more preferably 100 or less, and most preferably 55 or less. It is noted that the Mooney viscosity (ML₁₊₄ (100° C.)) in the present disclosure is a value measured according to JIS K6300 using an L rotor under the conditions of: a preheating time of 1 minute; a rotor revolution time of 4 minutes; and a temperature of 100° C.

The high-cis polybutadiene preferably has a molecular weight distribution Mw/Mn (Mw: weight average molecular weight, Mn: number average molecular weight) of 2.0 or more, more preferably 2.2 or more, even more preferably 2.4 or more, and most preferably 2.6 or more, and preferably has a molecular weight distribution Mw/Mn of 6.0 or less, more preferably 5.0 or less, even more preferably 4.0 or less, and most preferably 3.0 or less. If the molecular weight distribution (Mw/Mn) of the high-cis polybutadiene is excessively low, the processability deteriorates. If the molecular weight distribution (Mw/Mn) of the high-cis polybutadiene is excessively high, the resilience may be lowered. It is noted that the measurement of the molecular weight distribution is conducted by gel permeation chromatography (“HLC-8120GPC”, available from Tosoh Corporation) using a differential refractometer as a detector under the conditions of column: GMHHXL (available from Tosoh Corporation), column temperature: 40° C., and mobile phase: tetrahydrofuran, and calculated by converting based on polystyrene standard.

The rubber composition also preferably contains the polybutadiene rubber and the polyisoprene rubber as (a) the base rubber. The Mooney viscosity (ML₁₊₄ (100° C.)) of the polyisoprene rubber is preferably 55 or more, more preferably 60 or more, and even more preferably 65 or more, and is preferably 120 or less, more preferably 110 or less, and even more preferably 100 or less.

The mass ratio (polybutadiene rubber/polyisoprene rubber) of the polybutadiene rubber to the polyisoprene rubber in (a) the base rubber is preferably 1 or more, more preferably 2 or more, and even more preferably 4 or more, and is preferably 20 or less, more preferably 15 or less, and even more preferably 10 or less.

### [(b) Co-Crosslinking Agent]

(b) The α,β-unsaturated carboxylic acid having 3 to 8 carbon atoms and/or the metal salt thereof used in the rubber composition is blended as a co-crosslinking agent in the rubber composition, and has an action of crosslinking a rubber molecule by graft polymerization to a base rubber molecular chain.

Examples of the α,β-unsaturated carboxylic acid having 3 to 8 carbon atoms include acrylic acid, methacrylic acid, fumaric acid, maleic acid and crotonic acid.

Examples of the metal ion constituting the metal salt of the α,β-unsaturated carboxylic acid having 3 to 8 carbon atoms include a monovalent metal ion such as sodium, potassium and lithium; a divalent metal ion such as magnesium, calcium, zinc, barium and cadmium; a trivalent metal ion such as aluminum; and other metal ion such as tin and zirconium. The above metal component may be used solely or as a mixture of at least two of them. Among them, the divalent metal ion such as magnesium, calcium, zinc, barium and cadmium is preferably used as the metal component. This is because if the divalent metal salt of the α,β-unsaturated carboxylic acid having 3 to 8 carbon atoms is used, a metal crosslinking easily generates between the rubber molecules. Especially, as the divalent metal salt, zinc acrylate is preferable, because use of zinc acrylate enhances the resilience of the obtained golf ball. It is noted that the α,β-unsaturated carboxylic acid having 3 to 8 carbon atoms and/or the metal salt thereof may be used solely or as a mixture of at least two of them.

The amount of (b) the α,β-unsaturated carboxylic acid having 3 to 8 carbon atoms and/or the metal salt thereof is preferably 20 parts by mass or more, more preferably 25 parts by mass or more, and even more preferably 30 parts by mass or more, and is preferably 55 parts by mass or less, more preferably 50 parts by mass or less, and even more preferably 45 parts by mass or less, with respect to 100 parts by mass of (a) the base rubber. If the amount of (b) the α,β-unsaturated carboxylic acid having 3 to 8 carbon atoms and/or the metal salt thereof is less than 20 parts by mass, the amount of (c) the crosslinking initiator which will be described later must be increased such that the cured product (e.g. core) formed from the rubber composition has an appropriate hardness, which tends to lower the resilience of the obtained golf ball. On the other hand, if the amount of the α,β-unsaturated carboxylic acid having 3 to 8 carbon atoms and/or the metal salt thereof is more than 55 parts by mass, the cured product (e.g. core) formed from the rubber composition becomes so hard that the shot feeling of the obtained golf ball may be lowered.

### [(c) Crosslinking Initiator]

(c) The crosslinking initiator used in the rubber composition is blended to crosslink (a) the base rubber component. As (c) the crosslinking initiator, an organic peroxide is suitable. Specific examples of the organic peroxide include dicumyl peroxide, 1,1-di(t-butylperoxy)cyclohexane, 1,1-bis(t-butylperoxy)-3,3,5-trimethylcyclohexane, 2,5-dimethyl-2,5-di(t-butylperoxy) hexane and di-t-butyl peroxide. These organic peroxides may be used solely or as a mixture of at least two of them. Among them, dicumyl peroxide is preferably used.

The amount of (c) the crosslinking initiator is preferably 0.2 part by mass or more, more preferably 0.5 part by mass or more, and even more preferably 0.7 part by mass or more, and is preferably 5.0 parts by mass or less, more preferably 2.5 parts by mass or less, and even more preferably 2.0 parts by mass or less, with respect to 100 parts by mass of (a) the base rubber. If the amount of the crosslinking initiator is less than 0.2 part by mass, the cured product (e.g. core) formed from the rubber composition is so soft that the resilience of the obtained golf ball tends to be lowered, and if the amount of the crosslinking initiator is more than 5.0 parts by mass, the amount of (b) the co-crosslinking agent described above must be decreased such that the cured product (e.g. core) formed from the rubber composition has an appropriate hardness, which tends to lower the resilience or worsen the durability of the obtained golf ball.

### [(d) Radical Scavenger]

The golf ball rubber composition also preferably contains (d) a radical scavenger. Examples of (d) the radical scavenger include (d1) a hindered phenol-based compound and (d2) a hindered amine-based compound. If the golf ball rubber composition contains the component (d), the crosslinking density is lowered while the hardness of the cured product is kept.

### (d1) Hindered Phenol-Based Compound

(d1) The hindered phenol-based compound is a compound having a hydroxyphenyl structure with a hydroxy group thereof being sterically protected by a bulky functional group. The bulky functional group preferably exists at a location adjacent to the hydroxy group. Examples of the bulky functional group include t-butyl group, and a long chain alkyl group optionally having a part of the carbon atoms thereof substituted with a sulfur atom. As (d1) the hindered phenol-based compound, a compound having a tert-butylhydroxyphenyl structure with at least one tert-butyl group is preferable, a compound having a di-tert-butylhydroxyphenyl structure with two tert-butyl groups is more preferable.

Examples of the compound having the tert-butylhydroxyphenyl structure with at least one tert-butyl group include compounds having a structure such as 3-tert-butyl-4-hydroxyphenyl or 3,5-di-tert-butyl-4-hydroxyphenyl. Among them, the compound having 3,5-di-tert-butyl-4-hydroxyphenyl structure is preferable.

Specific examples of (d1) the hindered phenol-based compound include a compound having one hydroxyphenyl structure, such as dibutylhydroxy toluene (BHT), 4,6-bis(octylthiomethyl)-o-cresol, 4,6-bis[(dodecylthio)methyl]-o-cresol, 2,4-dimethyl-6-(1-methylpentadecyl) phenol (e.g. Irganox (registered trademark) 1141 available from BASF Japan Ltd.), and octadecyl-3-(3,5-di-t-butyl-4-hydroxyphenyl) propionate (e.g. ADK STAB (registered trademark) AO-50 available from Adeka Corporation).

Other specific examples of (d1) the hindered phenol-based compound include a compound having two hydroxyphenyl structures, such as 2,2′-methylene bis(4-ethyl-6-tert-butylphenol) (e.g. YOSHINOX (registered trademark) 425 available from Mitsubishi Chemical Corporation), 2,2′-methylene bis(4-methyl-6-tert-butylphenol) (e.g. Sandant (registered trademark) 2246 available from Sanshin Chemical Industry Co., Ltd.), 4,4′-butylidene bis(3-methyl-6-tert-butylphenol) (e.g. YOSHINOX BB available from Mitsubishi Chemical Corporation), 4,4′-thiobis(3-methyl-6-tert-butylphenol) (e.g. NOCRAC (registered trademark) 300 available from Ouchi Shinko Chemical Industrial Co., Ltd.), 4,4-methylene bis(2,6-di-tert-butylphenol), 2,6-di-tert-butyl-4-({2-[(3,5-di-tert-butyl-4-hydroxyphenyl) sulfanyl] propane-2-yl} sulfanyl) phenol (probucol), and 3,9-bis[2-[3-(3-tert-butyl-4-hydroxy-5-methylphenyl) propionyloxy]-1,1-dimethylethyl]-2,4,8,10-tetraoxaspiro[5.5] undecane (e.g. ADK STAB AO-80 available from Adeka Corporation).

Other specific examples of (d1) the hindered phenol-based compound include a compound having three hydroxyphenyl structures, such as 1,3,5-tris-(3,5-di-tert-butyl-4-hydroxybenzyl)-1,3-5-trazine-2,4,6(1H,3H,5H-)-trione (e.g. ADK STAB AO-20 available from Adeka Corporation), and 1,3,5-trimethyl-2,4,6-tris(3,5-di-t-butyl-4-hydroxybenzyl) benzene (e.g. ADK STAB AO330 available from Adeka Corporation).

Other specific examples of (d1) the hindered phenol-based compound include a compound having four hydroxyphenyl structures, such as pentaerythritol tetrakis[3-(3,5-di-tert-butyl-4-hydroxyphenyl) propionate] (e.g. ADK STAB AO-60 available from Adeka Corporation).

Other specific examples of (d1) the hindered phenol-based compound include 2-tert-butyl-6-(3-tert-butyl-2-hydroxy-5-methylbenzyl)-4-methylphenyl acrylate (e.g. SUMILIZER GM available from Sumitomo Chemical Co., Ltd.).

(d1) The hindered phenol-based compound may be used solely, or two or more of them may be used in combination.

Examples of (d1) the hindered phenol-based compound include 4,4′-butylidene bis(3-methyl-6-tert-butylphenol), 2,6-di-tert-butyl-4-({2-[(3,5-di-tert-butyl-4-hydroxyphenyl) sulfanyl] propane-2-yl} sulfanyl) phenol, and 2-tert-butyl-6-(3-tert-butyl-2-hydroxy-5-methylbenzyl)-4-methylphenyl acrylate.

### (d2) Hindered Amine-Based Compound

As (d2) the hindered amine-based compound, a compound having 2,2,6,6-tetramethyl-4-piperdyl group as represented by the following chemical formula (1) is preferable.

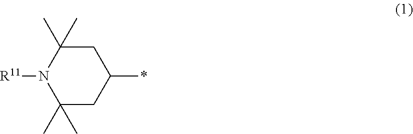

[In the formula (1), R¹¹ is a hydrogen atom, a hydroxy group, an alkyl group having 1 to 30 carbon atoms, a hydroxyalkyl group having 1 to 30 carbon atoms, an alkoxy group having 1 to 30 carbon atoms, a hydroxyalkoxy group having 1 to 30 carbon atoms, or an oxyradical, and * is a bonding site.]

The hindered amine-based compound represented by the chemical formula (1) includes a hindered amine-based compound as represented by the chemical formula (2) or chemical formula (3).

The hindered amine-based compound represented by the following chemical formula (2) is a so-called N-alkyl type hindered amine-based compound or NH type hindered amine-based compound.

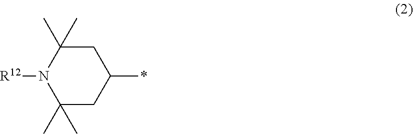

[In the formula (2), R¹² is a hydrogen atom, a hydroxy group, an alkyl group having 1 to 30 carbon atoms, a hydroxyalkyl group having 1 to 30 carbon atoms, or an oxyradical, and * is a bonding site.]

The hindered amine-based compound represented by the following chemical formula (3) is a so-called N-alkoxy type hindered amine compound.

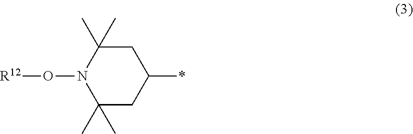

[In the chemical formula (3), R¹² is an alkyl group having 1 to 30 carbon atoms or a hydroxyalkyl group having 1 to 30 carbon atoms, and * is a bonding site.]

Specific examples of (d2) the hindered amine-based compound include compounds represented by the chemical formulae (4) to (6).

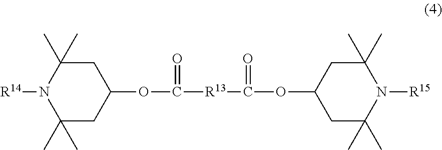

[In the chemical formula (4), R¹³ is an alkylene group having 1 to 30 carbon atoms, and R¹⁴ and R¹⁵ are each independently a hydrogen atom, a hydroxy group, an alkyl group having 1 to 30 carbon atoms, a hydroxyalkyl group having 1 to 30 carbon atoms, an alkoxy group having 1 to 30 carbon atoms, a hydroxyalkoxy group having 1 to 30 carbon atoms, or an oxyradical.]

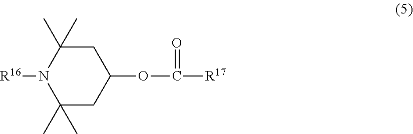

[In the chemical formula (5), R¹⁶ is a hydrogen atom, a hydroxy group, an alkyl group having 1 to 30 carbon atoms, a hydroxyalkyl group having 1 to 30 carbon atoms, an alkoxy group having 1 to 30 carbon atoms, a hydroxyalkoxy group having 1 to 30 carbon atoms, or an oxyradical, and R¹⁷ is an alkyl group having 1 to 30 carbon atoms, or an alkenyl group having 2 to 30 carbon atoms.]

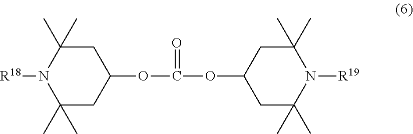

[In the chemical formula (6), R¹⁸ and R¹⁹ are each independently a hydrogen atom, a hydroxy group, an alkyl group having 1 to 30 carbon atoms, a hydroxyalkyl group having 1 to 30 carbon atoms, an alkoxy group having 1 to 30 carbon atoms, a hydroxyalkoxy group having 1 to 30 carbon atoms, or an oxyradical.]

Specific examples of (d2) the hindered amine compound include ADK STAB LA-52 (tetrakis(1,2,2,6,6-pentamethyl-4-piperdyl) butane-1,2,3,4-tetracarboxylate), ADK STAB LA-57 (tetrakis(2,2,6,6-tetramethyl-4-piperidyl) butane-1,2,3,4-tetracarboxylate), ADK STAB LA-63P, ADK STAB LA-68, ADK STAB LA-72 (bis(1,2,2,6,6-pentamethyl-4-piperidyl) sebacate, ADK STAB LA-77Y (bis(2,2,6,6-tetramethyl-4-piperidyl) sebacate, and ADK STAB LA-81 (bis(1-undecanoxy-2,2,6,6-tetramethylpiperdine-4-yl) carbonate available from Adeka Corporation.

Specific examples of (d2) the hindered amine compound include the following products available from BASF Japan Ltd.
(1) Chimassorb (registered trademark) 2020FDL
1,6-Hexanediamine, N,N′-bis(2,2,6,6-tetramethyl-4-piperidinyl)-polymer with 2,4,6-trichloro-1,3,5-triazine, reaction products with N-butyl-1-butanamine and N-butyl-2,2,6,6-tetramethyl-4-piperdinamine
(2) Chimassorb 944FDL
Poly[[6-[(1,1,3,3-tetramethylbutyl) amino]-1,3,5-triazine-2,4-diyl][(2,2,6,6-tetramethyl-4-piperidinyl) imino]-1,6-hexanediyl[(2,2,6,6-tetramethyl-4-piperidinyl) imino]])
(3) TINUVIN (registered trademark) 622SF
Butanedioic acid, dimethylester, polymer with 4-hydroxy-2,2,6,6-tetramethyl-1-piperidine ethanol)
(4) TINUVIN PA144
Bis(1,2,2,6,6-pentamethyl-4-piperidinyl)-2-butyl-2-(4-hydroxy-3,5-di-tert-butylbenzyl) propanedioate
(d2) The hindered amine-based compound may be used solely, or two or more of them may be used in combination. In addition, (d1) the hindered phenol compound and (d2) the hindered amine compound may be used in combination.

The amount of (d) the radical scavenger is preferably 0.5 part by mass or more, more preferably 0.6 part by mass or more, and even more preferably 0.7 part by mass or more, and is preferably 4.0 parts by mass or less, more preferably less than 2.0 parts by mass, even more preferably 1.8 parts by mass or less, and most preferably 1.5 parts by mass or less, with respect to 100 parts by mass of (a) the base rubber. If the amount of (d) the radical scavenger falls within the above range, the effective crosslinking density is decreased for the amount of the co-crosslinking agent, the breaking strain is increased, and the durability is enhanced.

### [(e) Organic Sulfur Compound]

The rubber composition may further contain (e) an organic sulfur compound. If (e) the organic sulfur compound is contained, the obtained core has enhanced resilience.

As (e) the organic sulfur compound, at least one compound selected from the group consisting of thiols (thiophenols, thionaphthols), polysulfides, thiurams, thiocarboxylic acids, dithiocarboxylic acids, sulfenamides, dithiocarbamates, and thiazoles, is preferable.

Examples of the thiols include thiophenols and thionaphthols. Examples of the thiophenols include thiophenol; thiophenols substituted with a fluoro group, such as 4-fluorothiophenol, 2,4-difluorothiophenol, 2,5-difluorothiophenol, 2,6-difluorothiophenol, 2,4,5-trifluorothiophenol, 2,4,5,6-tetrafluorothiophenol and pentafluorothiophenol; thiophenols substituted with a chloro group, such as 2-chlorothiophenol, 4-chlorothiophenol, 2,4-dichlorothiophenol, 2,5-dichlorothiophenol, 2,6-dichlorothiophenol, 2,4,5-trchlorothiophenol, 2,4,5,6-tetrachlorothiophenol and pentachlorothiophenol; thiophenols substituted with a bromo group, such as 4-bromothiophenol, 2,4-dibromothiophenol, 2,5-dibromothiophenol, 2,6-dibromothiophenol, 2,4,5-tribromothiophenol, 2,4,5,6-tetrabromothiophenol and pentabromothiophenol; thiophenols substituted with an iodo group, such as 4-iodothiophenol, 2,4-diiodothiophenol, 2,5-diiodothiophenol, 2,6-diiodothiophenol, 2,4,5-triiodothiophenol, 2,4,5,6-tetraiodothiophenol and pentaiodothiophenol; and metal salts thereof. As the metal salt, zinc salt is preferable.

Examples of the thionaphthols (naphthalenethiols) include 2-thionaphthol, 1-thionaphthol, 1-chloro-2-thionaphthol, 2-chloro-1-thionaphthol, 1-bromo-2-thionaphthol, 2-bromo-1-thionaphthol, 1-fluoro-2-thionaphthol, 2-fluoro-1-thionaphthol, 1-cyano-2-thionaphthol, 2-cyano-1-thionaphthol, 1-acetyl-2-thionaphthol, 2-acetyl-1-thionaphthol, and metal salts thereof. Among them, 2-thionaphthol, 1-thionaphthol, and metal salts thereof are preferable. As the metal salt, a divalent metal salt is preferable, zinc salt is more preferable. Specific examples of the metal salt include zinc salt of 1-thionaphthol and zinc salt of 2-thionaphthol.

The polysulfides are organic sulfur compounds having a polysulfide bond, and examples thereof include disulfides, trisulfides, and tetrasulfides. As the polysulfides, diphenyl polysulfides are preferable.

Examples of the diphenyl polysulfides include diphenyl disulfide; diphenyl disulfides substituted with a halogen group, such as bis(4-fluorophenyl) disulfide, bis(2,5-difluorophenyl) disulfide, bis(2,6-difluorophenyl) disulfide, bis(2,4,5-trifluorophenyl) disulfide, bis(2,4,5,6-tetrafluorophenyl) disulfide, bis(pentafluorophenyl) disulfide, bis(4-chlorophenyl) disulfide, bis(2,5-dichlorophenyl) disulfide, bis(2,6-dichlorophenyl) disulfide, bis(2,4,5-trichlorophenyl) disulfide, bis(2,4,5,6-tetrachlorophenyl) disulfide, bis(pentachlorophenyl) disulfide, bis(4-bromophenyl) disulfide, bis(2,5-dibromophenyl) disulfide, bis(2,6-dibromophenyl) disulfide, bis(2,4,5-tribromophenyl) disulfide, bis(2,4,5,6-tetrabromophenyl) disulfide, bis(pentabromophenyl) disulfide, bis(4-iodophenyl) disulfide, bis(2,5-diiodophenyl) disulfide, bis(2,6-diiodophenyl) disulfide, bis(2,4,5-triiodophenyl) disulfide, bis(2,4,5,6-tetraiodophenyl) disulfide and bis(pentaiodophenyl) disulfide; and diphenyl disulfides substituted with an alkyl group, such as bis(4-methylphenyl) disulfide, bis(2,4,5-trimethylphenyl) disulfide, bis(pentamethylphenyl) disulfide, bis(4-t-butylphenyl) disulfide, bis(2,4,5-tri-t-butylphenyl) disulfide, and bis(penta-t-butylphenyl) disulfide.

Examples of the thiurams include thiuram monosulfides such as tetramethylthiuram monosulfide; thiuram disulfides such as tetramethylthiuram disulfide, tetraethylthiuram disulfide and tetrabutylthiuram disulfide; and thiuram tetrasulfides such as dipentamethylenethiuram tetrasulfide. Examples of the thiocarboxylic acids include naphthalene thiocarboxylic acid. Examples of the dithiocarboxylic acids include naphthalene dithiocarboxylic acid. Examples of the sulfenamides include N-cyclohexyl-2-benzothiazole sulfenamide, N-oxydiethylene-2-benzothiazole sulfenamide, and N-t-butyl-2-benzothiazole sulfenamide.

As (e) the organic sulfur compound, the thiophenols and/or the metal salts thereof, the thionaphthols and/or the metal salts thereof, the diphenyl disulfides, and the thiuram disulfides are preferable, 2,4-dichlorothiophenol, 2,6-difluorothiophenol, 2,6-dichlorothiophenol, 2,6-dibromothiophenol, 2,6-diiodothiophenol, 2,4,5-trichlorothiophenol, pentachlorothiophenol, 1-thionaphthol, 2-thionaphthol, diphenyl disulfide, bis(2,6-difluorophenyl) disulfide, bis(2,6-dichlorophenyl) disulfide, bis(2,6-dibromophenyl) disulfide, bis(2,6-diiodophenyl) disulfide, and bis(pentabromophenyl) disulfide are more preferable.

(e) The organic sulfur compound may be used solely, or two or more of them may be used in combination.

The amount of (e) the organic sulfur compound is preferably 0.05 part by mass or more, more preferably 0.1 part by mass or more, and even more preferably 0.2 part by mass or more, and is preferably 5.0 parts by mass or less, more preferably 3.0 parts by mass or less, and even more preferably 2.0 parts by mass or less, with respect to 100 parts by mass of (a) the base rubber. If the amount of (e) the organic sulfur compound is less than 0.05 part by mass, the effect of adding (e) the organic sulfur compound may not be obtained, and the resilience of the golf ball may not be enhanced. In addition, if the amount of (e) the organic sulfur compound is more than 5.0 parts by mass, the obtained golf ball has a great compression deformation amount and thus the resilience thereof may be lowered.

### [(f) Other Component]

The golf ball rubber composition preferably further contains a metal compound. The metal compound can be used as, for example, a neutralizing agent for the α,β-unsaturated carboxylic acid having 3 to 8 carbon atoms. In addition, the metal compound can also be used as a mass adjusting agent

Examples of the metal compound include a metal hydroxide such as magnesium hydroxide, zinc hydroxide, calcium hydroxide, sodium hydroxide, lithium hydroxide, potassium hydroxide, and copper hydroxide; a metal oxide such as magnesium oxide, calcium oxide, zinc oxide, and copper oxide; and a metal carbonate such as magnesium carbonate, zinc carbonate, calcium carbonate, sodium carbonate, lithium carbonate, and potassium carbonate. As the metal compound, the divalent metal compound is preferable, the zinc compound is more preferable. This is because the divalent metal compound reacts with the α,β-unsaturated carboxylic acid having 3 to 8 carbon atoms to form a metal crosslinking. In addition, if the zinc compound is used, the obtained golf ball has better resilience.

The metal compound may be used solely, or at least two of them may be used in combination. In addition, the amount of the metal compound may be appropriately adjusted according to the desired neutralization degree of (b) the α,β-unsaturated carboxylic acid having 3 to 8 carbon atoms.

The golf ball rubber composition may further contain an additive such as a pigment, a filler for adjusting weight or the like, a peptizing agent, and a softener, where necessary.

The filler blended in the golf ball rubber composition is mainly used as a mass adjusting agent for adjusting the mass of the golf ball obtained as a final product, and may be blended where necessary. Examples of the filler include an inorganic filler such as zinc oxide, barium sulfate, calcium carbonate, magnesium oxide, tungsten powder, and molybdenum powder. As the filler, zinc oxide is particularly preferable. It is considered that zinc oxide acts as a vulcanizing aid to increase the hardness of the cured product (e.g. the core as a whole).

The amount of the filler is preferably 0.5 part by mass or more, more preferably 1 part by mass or more, and is preferably 30 parts by mass or less, more preferably 25 parts by mass or less, and even more preferably 20 parts by mass or less with respect to 100 parts by mass of (a) the base rubber. If the amount of the filler is less than 0.5 part by mass, it is difficult to adjust the weight, and if the amount of the filler is more than 30 parts by mass, the weight proportion of the rubber component is decreased and thus the resilience tends to be lowered.

The amount of the peptizing agent is preferably 0.1 part by mass or more and 5 parts by mass or less with respect to 100 parts by mass of (a) the base rubber.

The cured product of the golf ball rubber composition may be used for any portion of the constituent member of the golf ball. For example, the cured product of the golf ball rubber composition is suitably used for a one-piece golf ball body, a core, or an intermediate layer. Among them, the cured product of the golf ball rubber composition is suitably used for a single layered core, an inner core layer and/or an outer core layer of a dual layered core composed of the inner core layer and the outer core layer.

### [Golf Ball]

The present disclosure also provides a golf ball comprising a constituent member, wherein at least a part of the constituent member is formed of the above-described cured product of the golf ball rubber composition. In a preferable embodiment of the golf ball according to the present disclosure, the golf ball comprises a core and at least one cover layer covering the core, wherein at least a part of the core is formed of the above-described cured product of the golf ball rubber composition. Next, the golf ball according to the present disclosure will be explained.

In the case that a part of the core is formed of the above-described cured product of the golf ball rubber composition, the core surface preferably satisfies the mathematical formula (1). Specifically, the mathematical formula (1) is preferably satisfied in a region from the core surface to a thickness of 0.5 mm. It is noted that the property of the cured product forming the core surface can be confirmed by evaluating a test piece cut off from the core. In addition, the property of the cured product forming the core surface can also be confirmed by evaluating a slab prepared from the rubber composition used for forming the core under the same condition for molding the core.

### [Core]

The core of the golf ball according to the present disclosure can be obtained by mixing and kneading the above-described golf ball rubber composition, and molding the same in a mold. The molding conditions are not particularly limited, but the molding is generally carried out at a temperature ranging from 130° C. to 200° C. under a pressure ranging from 2.9 MPa to 11.8 MPa for 10 minutes to 60 minutes. For example, it is preferable that the molding is carried out by heating the golf ball rubber composition at a temperature ranging from 130° C. to 200° C. for 10 minutes to 60 minutes.

The surface hardness (Hs) of the core is preferably 50 or more, more preferably 55 or more, and even more preferably 60 or more in Shore C hardness, and is preferably 95 or less, more preferably 90 or less, and even more preferably 85 or less in Shore C hardness. If the surface hardness (Hs) of the core is 50 or more in Shore C hardness, the core has better resilience. In addition, if the surface hardness (Hs) of the core is 95 or less in Shore C hardness, the core has further enhanced shot feeling on driver shots.

The hardness (H75) of the core at a point located at a distance of 75% of a core radius from the center of the core is preferably 68 or more, more preferably 70 or more, and even more preferably 72 or more in Shore C hardness, and is preferably 82 or less, more preferably 80 or less, and even more preferably 78 or less in Shore C hardness. If the hardness (H75) of the core at the point located at the distance of 75% of the core radius from the center of the core is 68 or more in Shore C hardness, the resilience is better. In addition, if the hardness (H75) of the core at the point located at the distance of 75% of the core radius from the center of the core is 82 or less in Shore C hardness, the shot feeling on driver shots is enhanced.

The center hardness (Ho) of the core is preferably 30 or more, more preferably 35 or more, and even more preferably 40 or more in Shore C hardness. If the center hardness (Ho) of the core is 30 or more in Shore C hardness, the core does not become excessively soft and thus has better resilience. In addition, the center hardness (Ho) of the core is preferably 70 or less, more preferably 68 or less, and even more preferably 67 or less in Shore C hardness. If the center hardness (Ho) of the core is 70 or less in Shore C hardness, the core does not become excessively hard and thus has better shot feeling.

The hardness difference (Hs−Ho) between the surface hardness (Hs) and the center hardness (Ho) of the core is preferably 5 or more, more preferably 6 or more, and even more preferably 8 or more in Shore C hardness, and is preferably 35 or less, more preferably 30 or less, and even more preferably 28 or less in Shore C hardness. If the hardness difference (Hs−Ho) between the surface hardness (Hs) and the center hardness (Ho) of the core is 5 or more in Shore C hardness, the obtained golf ball has better resilience. In addition, if the hardness difference (Hs−Ho) between the surface hardness (Hs) and the center hardness (Ho) of the core is 35 or less in Shore C hardness, the obtained golf ball has further enhanced shot feeling on driver shots.

When the hardness (H75) of the core at the point located at the distance of 75% of the core radius from the center of the core ranges from 70 to 80 in Shore C hardness, the ratio (Hs/H75) of the core surface hardness (Hs) to the hardness H75 is preferably 0.90 or more, more preferably 0.93 or more, and even more preferably 0.95 or more, and is preferably 1.20 or less, more preferably 1.15 or less, and even more preferably 1.10 or less. If the ratio (Hs/H75) falls within the above range, the shot feeling is further enhanced while the resilience is maintained.

The diameter of the core is preferably 34.8 mm or more, more preferably 36.8 mm or more, and even more preferably 38.8 mm or more, and is preferably 42.2 mm or less, more preferably 41.8 mm or less, even more preferably 41.2 mm or less, and most preferably 40.8 mm or less. If the diameter of the core is 34.8 mm or more, the cover does not become excessively thick and thus the resilience is better. On the other hand, if the diameter of the core is 42.2 mm or less, the cover does not become excessively thin and thus functions better.

When the core has a diameter in a range of from 34.8 mm to 42.2 mm, the compression deformation amount (shrinking amount along the compression direction) of the core when applying a load from 98 N as an initial load to 1275 N as a final load to the core is preferably 2.0 mm or more, more preferably 2.3 mm or more, and even more preferably 2.5 mm or more, and is preferably 5.0 mm or less, more preferably 4.5 mm or less, and even more preferably 4.3 mm or less. If the compression deformation amount is 2.0 mm or more, the shot feeling is better, and if the compression deformation amount is 5.0 mm or less, the resilience is better.

### [Cover]

The cover of the golf ball according to the present disclosure is formed from a cover composition containing a resin component. Examples of the resin component include an ionomer resin, a thermoplastic polyurethane elastomer having a trade name of “Elastollan (registered trademark)” available from BASF Japan Ltd., a thermoplastic polyamide elastomer having a trade name of “Pebax (registered trademark)” available from Arkema K. K., a thermoplastic polyester elastomer having a trade name of “Hytrel (registered trademark)” available from Du Pont-Toray Co., Ltd., and a thermoplastic styrene elastomer having a trade name of “Tefabloc (registered trademark)” available from Mitsubishi Chemical Corporation.

Examples of the ionomer resin include a product obtained by neutralizing at least a part of carboxyl groups in a binary copolymer composed of an olefin and an α,β-unsaturated carboxylic acid having 3 to 8 carbon atoms with a metal ion; a product obtained by neutralizing at least a part of carboxyl groups in a ternary copolymer composed of an olefin, an α,β-unsaturated carboxylic acid having 3 to 8 carbon atoms and an α,β-unsaturated carboxylic acid ester with a metal ion; and a mixture thereof. The olefin is preferably an olefin having 2 to 8 carbon atoms. Examples of the olefin include ethylene, propylene, butene, pentene, hexene, heptene and octene, and ethylene is particularly preferred. Examples of the α,β-unsaturated carboxylic acid having 3 to 8 carbon atoms include acrylic acid, methacrylic acid, fumaric acid, maleic acid and crotonic acid, and acrylic acid or methacrylic acid is particularly preferred. In addition, examples of the α,β-unsaturated carboxylic acid ester include a methyl ester, an ethyl ester, a propyl ester, a n-butyl ester, an isobutyl ester of acrylic acid, methacrylic acid, fumaric acid and maleic acid, and an acrylic acid ester or a methacrylic acid ester is particularly preferred. Among them, as the ionomer resin, a metal ion neutralized product of ethylene-(meth)acrylic acid binary copolymer or a metal ion neutralized product of ethylene-(meth)acrylic acid-(meth)acrylic acid ester ternary copolymer is preferred.

The cover composition for forming the cover of the golf ball according to the present disclosure preferably contains a thermoplastic polyurethane elastomer or an ionomer resin as the resin component. It is also preferred that when the ionomer resin is used, a thermoplastic styrene elastomer is used in combination. The amount of the polyurethane or ionomer resin in the resin component of the cover composition is preferably 50 mass % or more, more preferably 60 mass % or more, and even more preferably 70 mass % or more.

In addition to the resin component, the cover composition may further contain a pigment component such as a white pigment (e.g. titanium oxide), a blue pigment and a red pigment, a weight adjusting agent such as zinc oxide, calcium carbonate and barium sulfate, a dispersant, an antioxidant, an ultraviolet absorber, a light stabilizer, a fluorescent material or fluorescent brightener, as long as they do not impair the performance of the cover.

The amount of the white pigment (e.g. titanium oxide) is preferably 0.5 part or more, more preferably 1 part or more, and is preferably 10 parts or less, more preferably 8 parts or less, with respect to 100 parts by mass of the resin component constituting the cover. If the amount of the white pigment is 0.5 part by mass or more, it is possible to impart the opacity to the resultant cover. In addition, if the amount of the white pigment is more than 10 parts by mass, the durability of the resultant cover may deteriorate.

The slab hardness of the cover composition is preferably set in accordance with the desired performance of the golf ball. For example, in case of a so-called distance golf ball which focuses on a flight distance, the cover composition preferably has a slab hardness of 50 or more, more preferably 55 or more, and even more preferably 60 or more in shore D hardness, and preferably has a slab hardness of 80 or less, more preferably 70 or less, and even more preferably 68 or less in shore D hardness. If the cover composition has a slab hardness of 50 or more, the obtained golf ball has a higher launch angle and a lower spin rate on driver shots and iron shots, and thus travels a greater distance. In addition, if the cover composition has a slab hardness of 80 or less, the obtained golf ball has better durability. Further, in case of a so-called spin golf ball which focuses on controllability, the cover composition preferably has a slab hardness of less than 50, more preferably 45 or less, and even more preferably 40 or less in Shore D hardness, and preferably has a slab hardness of 20 or more, more preferably 25 or more, and even more preferably 30 or more in shore D hardness. If the cover composition has a slab hardness of less than 50 in Shore D hardness, the obtained golf ball readily stops on the green due to the high spin rate on approach shots. In addition, if the cover composition has a slab hardness of 20 or more in Shore D hardness, the abrasion resistance is enhanced. In case of a plurality of cover layers, the slab hardness of the cover composition constituting each layer may be identical or different.

Examples of the method of molding the cover of the golf ball according to the present disclosure include a method which comprises molding the cover composition into a hollow shell, covering the core with a plurality of the hollow shells and performing compression molding (preferably a method which comprises molding the cover composition into a hollow half-shell, covering the core with two of the half-shells and performing compression molding); and a method which comprises injection molding the cover composition directly onto the core.

When molding the cover in a compression molding method, molding of the half shell can be performed by either the compression molding method or the injection molding method, and the compression molding method is preferred. Compression molding the cover composition into a half shell is carried out, for example, under a pressure of 1 MPa or more and 20 MPa or less at a temperature of −20° C. or more and 70° C. or less relative to the flow beginning temperature of the cover composition. By performing the molding under the above conditions, the half shell having a uniform thickness is formed. Examples of the method for molding the cover by using the half shell include a method which comprises covering the core with two of the half shells and then performing compression molding. Compression molding half shells into the cover is carried out, for example, under a pressure of 0.5 MPa or more and 25 MPa or less at a temperature of −20° C. or more and 70° C. or less relative to the flow beginning temperature of the cover composition. By performing the molding under the above conditions, the golf ball cover having a uniform thickness can be formed.

In the case of injection molding the cover composition into the cover, the cover composition extruded in a pellet form may be used for injection molding, or the cover materials such as the base resin components and the pigment may be dry blended, followed by directly injection molding the blended materials. It is preferred to use upper and lower molds having a hemi-spherical cavity and pimples for forming the cover, wherein a part of the pimples also serves as a retractable hold pin. When molding the cover by injection molding, the hold pin is protruded to hold the core, the cover composition is charged and then cooled to obtain the cover. For example, the cover composition heated at a temperature ranging from 200° C. to 250° C. is charged into a mold held under a pressure of 9 MPa to 15 MPa for 0.5 to 5 seconds, and after cooling for 10 to 60 seconds, the mold is opened to obtain the cover.

Concave portions called “dimples” are usually formed on the surface of the cover when the cover is molded. The total number of dimples formed on the cover is preferably 200 or more and 500 or less. If the total number of dimples is 200 or more and 500 or less, the dimple effect is fully obtained. The shape (shape in a plan view) of the dimples formed on the cover includes, without limitation, a circle; a polygonal shape such as a roughly triangular shape, a roughly quadrangular shape, a roughly pentagonal shape and a roughly hexagonal shape; and other irregular shape. These shapes may be employed solely, or at least two of them may be employed in combination.

The thickness of the cover is preferably 4.0 mm or less, more preferably 3.0 mm or less, and even more preferably 2.0 mm or less. If the cover has a thickness of 4.0 mm or less, the resultant golf ball has better resilience or shot feeling. The thickness of the cover is preferably 0.3 mm or more, more preferably 0.4 mm or more, and even more preferably 0.5 mm or more. If the cover has a thickness of 0.3 mm or more, the durability or wear resistance of the cover is better. In the case that the golf ball comprises a plurality of cover layers, the total thickness of a plurality of cover layers preferably falls within the above range.

The golf ball body having the cover formed thereon is ejected from the mold, and is preferably subjected to surface treatments such as deburring, cleaning and sandblast where necessary. In addition, if desired, a paint film or a mark may be formed. The thickness of the paint film is not particularly limited, and is preferably 5 μm or more, more preferably 7 μm or more, and more preferably 9 μm or more, and is preferably 50 μm or less, more preferably 40 μm or less, and even more preferably 30 μm or less. If the thickness of the paint film is 5 μm or more, the paint film is hard to wear off due to the continued use of the golf ball, and if the thickness of the paint film is 50 μm or less, the dimple effect can be fully exerted.

### [Golf Ball]

The construction of the golf ball according to the present disclosure is not particularly limited, as long as the golf ball comprises a core and at least one cover layer covering the core. The FIGURE is a partially cutaway cross-sectional view of a golf ball 1 according to one embodiment of the present disclosure. The golf ball 1 has a spherical core 2, and a cover 3 covering the spherical core 2. A plurality of dimples 31 are formed on the surface of the cover. Other portions than the dimples 31 on the surface of the golf ball 1 are lands 32. The golf ball 1 is provided with a paint layer and a mark layer on an outer side of the cover 3, but these layers are not depicted.

The core is preferably spherical. In addition, the construction of the core may be either a single layered construction or a multiple layered construction, and the single layered construction is preferable. Unlike the multiple layered core, the single layered core does not have an energy loss at the interface of the multiple layered core when being hit, and thus has better resilience. In addition, the cover has a construction composed of at least one layer, and may have either a single layered construction or a multiple layered construction composed of at least two layers. Examples of the golf ball according to the present disclosure include a two-piece golf ball composed of a core and a single layered cover disposed around the core, and a multi-piece golf ball (including a three-piece golf ball) composed of a core and at least two cover layers disposed around the core. The present disclosure can be suitably applied to any one of the above golf balls.

The golf ball according to the present disclosure preferably has a diameter ranging from 40 mm to 45 mm. In light of satisfying the regulation of US Golf Association (USGA), the diameter is most preferably 42.67 mm or more. In light of prevention of air resistance, the diameter is more preferably 44 mm or less, and most preferably 42.80 mm or less. In addition, the golf ball according to the present disclosure preferably has a mass of 40 g or more and 50 g or less. In light of obtaining greater inertia, the mass is more preferably 44 g or more, and most preferably 45.00 g or more. In light of satisfying the regulation of USGA, the mass is most preferably 45.93 g or less.

When the golf ball has a diameter in a range of from 40 mm to 45 mm, the compression deformation amount (shrinking amount along the compression direction) of the golf ball when applying a load from an initial load of 98 N to a final load of 1275 N to the golf ball is preferably 2.0 mm or more, more preferably 2.3 mm or more, and even more preferably 2.5 mm or more, and is preferably 4.0 mm or less, more preferably 3.5 mm or less, and even more preferably 3.3 mm or less. If the compression deformation amount is 2.0 mm or more, the golf ball does not become excessively hard, and thus has better shot feeling. On the other hand, if the compression deformation amount is 4.0 mm or less, the golf ball has better resilience.

### EXAMPLES

Next, the present disclosure will be described in detail by way of examples. However, the present disclosure is not limited to the examples described below. Various changes and modifications without departing from the spirit of the present disclosure are included in the scope of the present disclosure.

### [Evaluation Methods]

### (1) Effective Crosslinking Density (Mmol/Cm³)

The effective crosslinking density of the cured product of the golf ball rubber composition is calculated based on a swelling measurement of a slab sample of the cured product of the golf ball rubber composition. The golf ball rubber composition was kneaded with a kneading roll and heated at a temperature of 170° C. for 30 minutes to produce a slab with a thickness of 0.5 mm, a length of 12 cm and a width of 14 cm. From this slab, a slab with a thickness of 0.5 mm and a dimension of 2 cm×2 cm was cut off and used as a test slab sample.

The swelling measurement was conducted by immersing the obtained slab sample in toluene (molecular weight: 92 mol/g) at a temperature of 40° C. for 24 hours. The masses of the slab before and after the swelling (23° C.) were measured, and the effective crosslinking density was calculated using the following Flory-Rehner formula.

$$v ( m mol / {cm}^{3} ) = \frac{{V}_{R} + ln ( 1 - {V}_{R} ) + μ {V}_{R}^{2}}{- {V}_{0} ( {V}_{R}^{1 / 3} - \frac{{V}_{R}}{2} )} \times {10}^{3}$$

v effective crosslinking density
V₀: molar volume of solvent (toluene) (108.15 cm³/mol)
μ: interaction constant of base rubber-solvent (toluene) (0.49)

$${V}_{R} = \frac{{V}_{BR}}{{V}_{BR} + {V}_{T}}$$

$${V}_{BR} = \frac{{W}_{F} {v}_{F}}{ρ}$$

$${V}_{T} = \frac{{W}_{S} - {W}_{F}}{{ρ}_{T}}$$

V_{BR}: volume of base rubber in rubber composition
V_{T}: volume of toluene absorbed by swelling
W_{F}: mass of sample before swelling
W_{S}: mass of sample after swelling
v_{F}: mass proportion of base rubber in rubber composition
ρ: density of base rubber
ρ_{T}: density (37° C.) of toluene (0.8507 g/cm³)

### (2) Tensile Test

The tensile test for the cured product of the rubber composition was conducted according to JIS K6254 (2016). Specifically, the rubber composition was kneaded with a kneading roll and heated at a temperature of 170° C. for 30 minutes, to prepare a slab with a thickness of 2.0 mm. Two test pieces were punched from the slab and stored at a temperature of 23° C. for two weeks. The test piece had a shape of a strip-shaped type V (width: 15 mm, total length: 100 mm, thickness: 2.0 mm, gauge length: 20 mm).

The tensile test was conducted with a precision universal tester (AUTOGRAPH (registered trademark) AG-X plus available from Shimadzu Corporation) under conditions of a testing temperature: 23° C., a length between grips: 60 mm and a moving speed of grips: 50 mm/min. In the tensile test, the test piece was elongated until the test piece was broken, and the tensile stress was recorded at respective elongation. The tensile modulus was calculated according to the following formula.

Tensile modulus=(σ_{0.25}−σ_{0.05})/(0.0025−0.0005)
σ_{0.25}: tensile stress at 0.25% elongation
σ_{0.05}: tensile stress at 0.05% elongation

### (3) Core Hardness

The Shore C hardness measured at the surface of the core with an automatic hardness tester Digitest II available from Bareiss company was adopted as the surface hardness of the core. In addition, the core was cut into two hemispheres to obtain a cut plane, and the hardness at the central point of the cut plane and the hardness at the point located at the predetermined distance of the core radius from the central point of the cut plane were measured. It is noted that the hardness at the point located at the predetermined distance of the core radius from the central point of the cut plane was calculated by measuring the hardness values at four points located at the predetermined distance of the core radius from the central point of the cut plane and averaging the hardness values measured at the four points.

### (4) Compression Deformation Amount (Mm)

The deformation amount along the compression direction of the core or golf ball (shrinking amount along the compression direction of the core or golf ball), when applying a load from an initial load of 98 N to a final load of 1275 N to the core or golf ball, was measured.

### (5) Slab Hardness (Cover Composition)

Sheets with a thickness of about 2 mm were produced by injection molding the cover composition. The sheets were stored at a temperature of 23° C. for two weeks. At least three of these sheets were stacked on one another so as not to be affected by the measuring substrate on which the sheets were placed, and the hardness of the stack was measured with an automatic hardness tester (Digitest II, available from Bareiss company) using a testing device of “Shore D”.

### (6) Durability

A W #1 driver provided with a metal head (XXIO S, loft angel: 11°, available from Sumitomo Rubber Industries, Ltd.) was installed on a swing robot M/C available from Golf Laboratories, Inc. The golf ball was hit repeatedly at a head speed of 45 m/sec until crack occurred, and the hitting times when the crack occurred were counted. It is noted that the measurement was conducted using twelve samples for each golf ball, and the average value thereof was adopted as the hitting times for that golf ball.

### Grading Standard

G (Good): Durability of the golf ball is at least 4% higher than that of the comparative example (standard, No. 19)
F (Fair): Durability of the golf ball is at least 2% and less than 4% higher than that of the comparative example (standard, No. 19)
P (Poor): Durability of the golf ball is equal to or lower than that of the comparative example (standard, No. 19)

### (7) Shot Feeling

An actual hitting test was carried out by ten amateur golfers (high skilled persons) using a driver. In accordance with the following grading standard, the feeling of the golf ball at hitting was evaluated by each golfer.

### Grading Standard

G (Good): At least eight golfers answer that the golf ball has better feeling than the comparative example (standard, No. 19)
F (Fair): Five to seven golfers answer that the golf ball has better feeling than the comparative example (standard, No. 19)
P (Poor): At most four golfers answer that the golf ball has better feeling than the comparative example (standard, No. 19)

### [Production of Golf Ball]

### (1) Production of Core

The rubber compositions having the formulations shown in Tables 1 to 3 were kneaded with a kneading roll, and heat-pressed in upper and lower molds, each having a hemispherical cavity, at a temperature of 170° C. for 30 minutes to produce spherical cores having a diameter of 39.7 mm. It is noted that an appropriate amount of barium sulfate was added such that the obtained golf ball had a mass of 45.3 g.

TABLE 1

| Golf ball No. | | | 1 | 2 | 3 | 4 | 5 | 6 |
|---|---|---|---|---|---|---|---|---|
| Core rubber | Formulation | (a) BR730 | 100 | 100 | 100 | 100 | 100 | 100 |
| composition | (parts by | (b) ZN-DA90S | 26 | 28 | 38 | 44 | 49 | 55 |
| | mass) | (c) Dicumyl peroxide (DCP) | 0.8 | 0.8 | 0.8 | 0.8 | 0.8 | 0.8 |
| | | Zinc oxide | 5.0 | 5.0 | 5.0 | 5.0 | 5.0 | 5.0 |
| | | PCTP-Zn | 1.0 | 1.0 | 1.0 | 1.0 | 1.0 | 1.0 |
| | | (d) Probucol | 0.05 | 0.10 | 0.50 | 1.00 | 1.50 | 2.00 |
| | | Barium sulfate | appropriate | appropriate | appropriate | appropriate | appropriate | appropriate |
| | | | amount | amount | amount | amount | amount | amount |
| | Property of | Effective crosslinking density | 2.00 | 1.30 | 0.91 | 0.67 | 0.64 | 0.50 |
| | cured | DC (mmol/cm³) | | | | | | |
| | product | Tensile modulus TM (MPa) | 140 | 180 | 206 | 230 | 285 | 200 |
| | | In(DC) | 0.69 | 0.26 | −0.09 | −0.39 | −0.45 | −0.69 |
| | | TM-333.32*In(DC) | −91 | 93 | 239 | 362 | 436 | 431 |

| | | | | | | | |
|---|---|---|---|---|---|---|---|
| Property of | Compression deformation amount (mm) | 3.6 | 3.6 | 3.6 | 3.6 | 3.6 | 3.6 |
| core | Center hardness H0 (Shore C) | 63 | 64 | 62 | 70 | 64 | 66 |
| | Hardness H12.5 at 12.5% point (Shore C) | 70 | 70 | 70 | 72 | 68 | 68 |
| | Hardness H25 at 25% point (Shore C) | 72 | 73 | 75 | 77 | 72 | 72 |
| | Hardness H37.5 at 37.5% point (Shore C) | 73 | 73 | 75 | 77 | 74 | 71 |
| | Hardness H50 at 50% point (Shore C) | 74 | 74 | 74 | 77 | 77 | 73 |
| | Hardness H62.5 at 62.5% point (Shore C) | 74 | 74 | 75 | 76 | 76 | 73 |
| | Hardness H75 at 75% point (Shore C) | 75 | 76 | 76 | 74 | 75 | 72 |
| | Surface hardness Hs (Shore C) | 84 | 82 | 80 | 77 | 74 | 70 |
| | Surface hardness Hs-center hardness | 21 | 18 | 18 | 7 | 10 | 4 |
| | H0 (Shore C) | | | | | | |
| | Surface hardness Hs/hardness H75 at | 1.12 | 1.08 | 1.05 | 1.04 | 0.99 | 0.97 |
| | 75% point | | | | | | |
| Golf ball | Compression deformation amount (mm) | 3.0 | 3.0 | 3.0 | 3.0 | 3.0 | 3.0 |
| | Durability | F | F | G | G | G | F |
| | Shot feeling | P | P | G | G | G | G |

TABLE 2

| Golf ball No. | | | 7 | 8 | 9 | 10 | 11 | 12 |
|---|---|---|---|---|---|---|---|---|
| Core rubber | Formulation | (a) BR730 | 100 | 100 | 100 | 100 | 100 | 100 |
| composition | (parts by | (b) ZN-DA90S | 25 | 32 | 34 | 36 | 38 | 40 |
| | mass) | (c) Dicumyl peroxide (DCP) | 0.8 | 0.8 | 0.8 | 0.8 | 0.8 | 0.8 |
| | | Zinc oxide | 5.0 | 5.0 | 5.0 | 5.0 | 5.0 | 5.0 |
| | | PCTP-Zn | 1.0 | 1.0 | 1.0 | 1.0 | 1.0 | 1.0 |
| | | (d) 4,4'-butylidene bis(3-methyl- | 0.10 | 0.50 | 1.00 | 1.50 | 2.00 | 4.00 |
| | | 6-tert-butylphenol) | | | | | | |
| | | Barium sulfate | appropriate | appropriate | appropriate | appropriate | appropriate | appropriate |
| | | | amount | amount | amount | amount | amount | amount |
| | Property of | Effective crosslinking density | 2.00 | 0.91 | 0.73 | 0.70 | 0.65 | 0.50 |
| | cured | DC (mmol/cm³) | | | | | | |
| | product | Tensile modulus TM (MPa) | 140 | 114 | 131 | 92 | 80 | 70 |
| | | In(DC) | 0.69 | −0.09 | −0.31 | −0.36 | −0.43 | −0.69 |
| | | TM-333.32*In(DC) | −91 | 143 | 234 | 212 | 224 | 301 |

| | | | | | | | |
|---|---|---|---|---|---|---|---|
| Property of | Compression deformation amount (mm) | 3.6 | 3.6 | 3.6 | 3.6 | 3.6 | 3.6 |
| core | Center hardness H0 (Shore C) | 63 | 64 | 66 | 67 | 67 | 66 |
| | Hardness H12.5 at 12.5% point (Shore C) | 70 | 71 | 71 | 71 | 68 | 68 |
| | Hardness H25 at 25% point (Shore C) | 72 | 73 | 74 | 73 | 73 | 72 |
| | Hardness H37.5 at 37.5% point (Shore C) | 73 | 73 | 74 | 75 | 73 | 71 |
| | Hardness H50 at 50% point (Shore C) | 74 | 73 | 75 | 77 | 75 | 73 |
| | Hardness H62.5 at 62.5% point (Shore C) | 74 | 74 | 77 | 76 | 74 | 73 |
| | Hardness H75 at 75% point (Shore C) | 75 | 77 | 76 | 74 | 74 | 72 |
| | Surface hardness Hs (Shore C) | 84 | 79 | 76 | 76 | 73 | 70 |
| | Surface hardness Hs-center hardness | 21 | 15 | 10 | 9 | 6 | 4 |
| | H0 (Shore C) | | | | | | |
| | Surface hardness Hs/hardness H75 at | 1.12 | 1.03 | 1.00 | 1.03 | 0.99 | 0.97 |
| | 75% point | | | | | | |
| Golf ball | Compression deformation amount (mm) | 3.0 | 3.0 | 3.0 | 3.0 | 3.0 | 3.0 |
| | Durability | F | G | G | G | F | F |
| | Shot feeling | P | G | G | G | G | G |

TABLE 3

| Golf ball No. | | | 13 | 14 | 15 | 16 | 17 | 18 | 19 |
|---|---|---|---|---|---|---|---|---|---|
| Core rubber | Formulation | (a) BR730 | 100 | 100 | 100 | 100 | 100 | 100 | 100 |
| composition | (parts by | (b) ZN-DA90S | 25 | 33 | 35 | 41 | 45 | 55 | 25 |
| | mass) | (c) Dicumyl | 0.8 | 0.8 | 0.8 | 0.8 | 0.8 | 0.8 | 0.8 |
| | | peroxide (DCP) | | | | | | | |
| | | Zinc oxide | 5.0 | 5.0 | 5.0 | 5.0 | 5.0 | 5.0 | 5.0 |
| | | PCTP-Zn | 1.0 | 1.0 | 1.0 | 1.0 | 1.0 | 1.0 | — |
| | | (d) 2-tert-butyl- | 0.10 | 0.50 | 1.00 | 1.50 | 2.00 | 4.00 | — |
| | | 6-(3-tert-butyl- | | | | | | | |
| | | 2-hydroxy-5- | | | | | | | |
| | | methylbenzyl)-4- | | | | | | | |
| | | methylphenyl | | | | | | | |
| | | acrylate | | | | | | | |
| | | Barium sulfate | appropriate | appropriate | appropriate | appropriate | appropriate | appropriate | appropriate |
| | | | amount | amount | amount | amount | amount | amount | amount |
| | Property of | Effective | 2.00 | 1.23 | 1.04 | 0.67 | 0.65 | 0.50 | 2.07 |
| | cured | crosslinking density | | | | | | | |
| | product | DC (mmol/cm³) | | | | | | | |
| | | Tensile modulus | 140 | 213 | 216 | 162 | 80 | 70 | 131 |
| | | TM (MPa) | | | | | | | |
| | | In(DC) | 0.69 | 0.21 | 0.04 | −0.41 | −0.43 | −0.69 | 0.73 |
| | | TM-333.32*In(DC) | −91 | 145 | 204 | 297 | 224 | 301 | −111 |

| | | | | | | | | |
|---|---|---|---|---|---|---|---|---|
| Property of | Compression deformation | 3.6 | 3.6 | 3.6 | 3.6 | 3.6 | 3.6 | 3.6 |
| core | amount (mm) | | | | | | | |
| | Center hardness H0 (Shore C) | 63 | 59 | 59 | 62 | 67 | 66 | 63 |
| | Hardness H12.5 at 12.5% | 70 | 68 | 69 | 68 | 68 | 68 | 69 |
| | point (Shore C) | | | | | | | |
| | Hardness H25 at 25% | 72 | 73 | 74 | 72 | 73 | 72 | 72 |
| | point (Shore C) | | | | | | | |
| | Hardness H37.5 at 37.5% | 73 | 74 | 74 | 72 | 73 | 71 | 73 |
| | point (Shore C) | | | | | | | |
| | Hardness H50 at 50% | 74 | 73 | 74 | 75 | 75 | 73 | 74 |
| | point (Shore C) | | | | | | | |
| | Hardness H62.5 at 62.5% | 74 | 71 | 74 | 77 | 74 | 73 | 73 |
| | point (Shore C) | | | | | | | |
| | Hardness H75 at 75% | 75 | 75 | 77 | 75 | 74 | 72 | 77 |
| | point (Shore C) | | | | | | | |
| | Surface hardness Hs (Shore C) | 84 | 84 | 79 | 74 | 73 | 70 | 86 |
| | Surface hardness Hs-center | 21 | 25 | 20 | 12 | 6 | 4 | 23 |
| | hardness H0 (Shore C) | | | | | | | |
| | Surface hardness Hs/hardness | 1.12 | 1.12 | 1.03 | 0.99 | 0.99 | 0.97 | 1.12 |
| | H75 at 75% point | | | | | | | |
| Golf ball | Compression deformation | 3.0 | 3.0 | 3.0 | 3.0 | 3.0 | 3.0 | 3.0 |
| | amount (mm) | | | | | | | |
| | Durability | F | G | G | G | F | F | P |
| | Shot feeling | P | G | G | G | G | G | P |

The materials used in Tables 1 to 3 are shown as follows.
BR730: high-cis polybutadiene rubber (cis-1,4 bond amount=95 mass %, 1,2-vinyl bond amount=1.3 mass %, Moony viscosity (ML₁₊₄ (100° C.))=55, molecular weight distribution (Mw/Mn)=3) available from JSR Corporation
ZN-DA90S: zinc acrylate (surface-treated with zinc stearate in an amount of 10%) available from Nisshoku Techno Fine Chemical Co., Ltd.
DCP: PERCUMYL (registered trademark) D (one-minute half-life temperature: 175.2° C.) (purity of dicumyl peroxide: at least 98%) available from NOF Corporation
Zinc oxide: available from Indo Lysaght Corporation
PCTP-Zn: zinc salt of pentachlorothiophenol available from FUJIFILM Wako Pure Chemical Corporation
Probucol: 2,6-di-tert-butyl-4-({2-[(3,5-di-tert-butyl-4-hydroxyphenyl) sulfanyl]propane-2-yl} sulfanyl) phenol available from Tokyo Chemical Industry Co., Ltd.
4,4′-butylidene bis(3-methyl-6-tert-butylphenol): available from Tokyo Chemical Industry Co., Ltd.
2-tert-butyl-6-(3-tert-butyl-2-hydroxy-5-methylbenzyl)-4-methylphenyl acrylate: available from Tokyo Chemical Industry Co., Ltd.
Barium sulfate: “Barium sulfate BD” available from Sakai Chemical Industry Co., Ltd.

### (2) Production of Cover and Production of Golf Ball

According to the formulation shown in Table 4, the cover materials were extruded with a twin-screw kneading type extruder to prepare the cover composition in a pellet form. The conditions for extruding the cover composition were a screw diameter of 45 mm, a screw rotational speed of 200 rpm, and screw L/D=35, and the mixture was heated to 160 to 230° C. at the die position of the extruder. The obtained cover composition was injection molded onto the spherical core obtained above such that the formed cover had a thickness of 1.5 mm, to produce golf balls having the spherical core and the cover covering the core. Evaluation results of the obtained golf balls are shown in Tables 1 to 3.

TABLE 4
Cover composition

| | | |
|---|---|---|
| Formulation (parts by mass) | Himilan 1555 | 40 |
| | Himilan 1605 | 20 |
| | Himilan AM7329 | 40 |
| | Titanium dioxide (A220) | 3 |
| | JF-90 | 0.2 |

| | |
|---|---|
| Slab hardness (Shore D) | 63 |

The materials used in Table 4 are shown as follows.
Himilan (registered trademark) 1555: Na ion-neutralized ionomer available from Du Pont-Mitsui Polychemicals Co., Ltd.
Himilan 1605: Na ion-neutralized ionomer available from Du Pont-Mitsui Polychemicals Co., Ltd.
Himilan AM7329: Zn ion-neutralized ionomer available from Du Pont-Mitsui Polychemicals Co., Ltd.
A-220: titanium dioxide available from Ishihara Sangyo Kaisha, Ltd.
JF-90: light stabilizer available from Johoku Chemical Co., Ltd.

It can be seen from the results shown in Tables 1 to 3 that the cured product of the golf ball rubber composition containing (a) a base rubber, (b) an α,β-unsaturated carboxylic acid having 3 to 8 carbon atoms and/or a metal salt thereof as a co-crosslinking agent, and (c) a crosslinking initiator, wherein an effective crosslinking density DC (mmol/cm³) of the cured product and a tensile modulus TM (MPa) of the cured product at a strain from 0.05% to 0.25% satisfy a relationship of the mathematical formula (1): TM−333.32×ln(DC)>100 . . . (1), imparts excellent durability to a golf ball without lowering shot feeling of the golf ball.

In addition, the golf ball according to the present disclosure has excellent durability while having maintained good shot feeling.

This application is based on Japanese Patent application No. 2022-077660 filed on May 10, 2022, the content of which is hereby incorporated by reference.

The preferable embodiment (1) according to the present disclosure is a cured product of a golf ball rubber composition containing (a) a base rubber, (b) an α,β-unsaturated carboxylic acid having 3 to 8 carbon atoms and/or a metal salt thereof as a co-crosslinking agent, and (c) a crosslinking initiator, wherein an effective crosslinking density DC (mmol/cm³) of the cured product and a tensile modulus TM (MPa) of the cured product at a strain from 0.05% to 0.25% satisfy a relationship of the mathematical formula (1):

TM−333.32×ln(DC)>100 (1).

The preferable embodiment (2) according to the present disclosure is the cured product of the preferable embodiment (1), wherein the golf ball rubber composition further contains (d) a radical scavenger.

The preferable embodiment (3) according to the present disclosure is the cured product of the preferable embodiment (2), wherein (d) the radical scavenger includes a hindered phenol-based compound or a hindered amine-based compound.

The preferable embodiment (4) according to the present disclosure is the cured product of the preferable embodiment (3), wherein the hindered phenol-based compound includes at least one member selected from the group consisting of 4,4′-butylidene bis(3-methyl-6-tert-butylphenol), 2,6-di-tert-butyl-4-({2-[(3,5-di-tert-butyl-4-hydroxyphenyl) sulfanyl] propane-2-yl} sulfanyl) phenol, and 2-tert-butyl-6-(3-tert-butyl-2-hydroxy-5-methylbenzyl)-4-methylphenyl acrylate.

The preferable embodiment (5) according to the present disclosure is the cured product of the golf ball rubber composition according to any one of the preferable embodiments (1) to (4), wherein the golf ball rubber composition contains (d) the radical scavenger in an amount of 0.5 part by mass or more and 4 parts by mass or less with respect to 100 parts by mass of (a) the base rubber.

The preferable embodiment (6) according to the present disclosure is the cured product of the golf ball rubber composition according to any one of the preferable embodiments (1) to (4), wherein the golf ball rubber composition contains (d) the radical scavenger in an amount of 0.5 part by mass or more and less than 2 parts by mass with respect to 100 parts by mass of (a) the base rubber.

The preferable embodiment (7) according to the present disclosure is the cured product of the golf ball rubber composition according to any one of the preferable embodiments (1) to (4), wherein the golf ball rubber composition contains (d) the radical scavenger in an amount of 0.5 part by mass or more and 1.5 parts by mass or less with respect to 100 parts by mass of (a) the base rubber.

The preferable embodiment (8) according to the present disclosure is the cured product of the golf ball rubber composition according to any one of the preferable embodiments (1) to (7), wherein the golf ball rubber composition further contains, as (e) an organic sulfur compound, at least one compound selected from the group consisting of thiols, polysulfides, thiurams, thiocarboxylic acids, dithiocarboxylic acids, sulfenamides, dithiocarbamates, and thiazoles.

The preferable embodiment (9) according to the present disclosure is a golf ball comprising a constituent member, wherein at least a part of the constituent member is formed from the cured product of the golf ball rubber composition according to any one of the preferable embodiments (1) to (8).

The preferable embodiment (10) according to the present disclosure is a golf ball comprising a core and at least one cover layer covering the core, wherein the core is formed from the cured product of the golf ball rubber composition according to any one of the preferable embodiments (1) to (8).

The preferable embodiment (11) according to the present disclosure is the golf ball of the preferable embodiment (10), wherein a ratio (Hs/H75) of a surface hardness (Hs) of the core to a hardness (H75) of the core at a point located at a distance of 75% of a core radius from a center of the core is 0.90 or more and 1.20 or less when the hardness H75 of the core ranges from 70 to 80 in Shore C hardness.

1. A cured product of a golf ball rubber composition containing (a) a base rubber, (b) an β,β-unsaturated carboxylic acid having 3 to 8 carbon atoms and/or a metal salt thereof as a co-crosslinking agent, and (c) a crosslinking initiator, wherein an effective crosslinking density DC (mmol/cm³) of the cured product and a tensile modulus TM (MPa) of the cured product at a strain from 0.05% to 0.25% satisfy a relationship of the mathematical formula (1):
TM−333.32×ln(DC)>100 (1).

2. The cured product of the golf ball rubber composition according to claim 1, wherein the golf ball rubber composition further contains (d) a radical scavenger.

3. The cured product of the golf ball rubber composition according to claim 2, wherein (d) the radical scavenger includes a hindered phenol-based compound or a hindered amine-based compound.

4. The cured product of the golf ball rubber composition according to claim 3, wherein the hindered phenol-based compound includes at least one member selected from the group consisting of 4,4′-butylidene bis(3-methyl-6-tert-butylphenol), 2,6-di-tert-butyl-4-({2-[(3,5-di-tert-butyl-4-hydroxyphenyl) sulfanyl]propane-2-yl} sulfanyl) phenol, and 2-tert-butyl-6-(3-tert-butyl-2-hydroxy-5-methylbenzyl)-4-methylphenyl acrylate.

5. The cured product of the golf ball rubber composition according to claim 2, wherein the golf ball rubber composition contains (d) the radical scavenger in an amount of 0.5 part by mass or more and 4 parts by mass or less with respect to 100 parts by mass of (a) the base rubber.

6. The cured product of the golf ball rubber composition according to claim 2, wherein the golf ball rubber composition contains (d) the radical scavenger in an amount of 0.5 part by mass or more and less than 2 parts by mass with respect to 100 parts by mass of (a) the base rubber.

7. The cured product of the golf ball rubber composition according to claim 2, wherein the golf ball rubber composition contains (d) the radical scavenger in an amount of 0.5 part by mass or more and 1.5 parts by mass or less with respect to 100 parts by mass of (a) the base rubber.

8. The cured product of the golf ball rubber composition according to claim 1, wherein the golf ball rubber composition further contains, as (e) an organic sulfur compound, at least one compound selected from the group consisting of thiols, polysulfides, thiurams, thiocarboxylic acids, dithiocarboxylic acids, sulfenamides, dithiocarbamates, and thiazoles.

9. A golf ball comprising a constituent member, wherein at least a part of the constituent member is formed of a cured product of a golf ball rubber composition containing (a) a base rubber, (b) an α,β-unsaturated carboxylic acid having 3 to 8 carbon atoms and/or a metal salt thereof as a co-crosslinking agent, and (c) a crosslinking initiator, and an effective crosslinking density DC (mmol/cm³) of the cured product and a tensile modulus TM (MPa) of the cured product at a strain from 0.05% to 0.25% satisfy a relationship of the mathematical formula (1):
TM−333.32×ln(DC)>100 (1).

10. The golf ball according to claim 9, wherein the golf ball rubber composition further contains (d) a radical scavenger.

11. The golf ball according to claim 10, wherein (d) the radical scavenger includes a hindered phenol-based compound or a hindered amine-based compound.

12. The golf ball according to claim 11, wherein the hindered phenol-based compound includes at least one member selected from the group consisting of 4,4′-butylidene bis(3-methyl-6-tert-butylphenol), 2,6-di-tert-butyl-4-({2-[(3,5-di-tert-butyl-4-hydroxyphenyl) sulfanyl] propane-2-yl} sulfanyl) phenol, and 2-tert-butyl-6-(3-tert-butyl-2-hydroxy-5-methylbenzyl)-4-methylphenyl acrylate.

13. The golf ball according to claim 10, wherein the golf ball rubber composition contains (d) the radical scavenger in an amount of 0.5 part by mass or more and 4 parts by mass or less with respect to 100 parts by mass of (a) the base rubber.

14. The golf ball according to claim 10, wherein the golf ball rubber composition contains (d) the radical scavenger in an amount of 0.5 part by mass or more and less than 2 parts by mass with respect to 100 parts by mass of (a) the base rubber.

15. The golf ball according to claim 10, wherein the golf ball rubber composition contains (d) the radical scavenger in an amount of 0.5 part by mass or more and 1.5 parts by mass or less with respect to 100 parts by mass of (a) the base rubber.

16. The golf ball according to claim 9, wherein the golf ball rubber composition further contains, as (e) an organic sulfur compound, at least one compound selected from the group consisting of thiols, polysulfides, thiurams, thiocarboxylic acids, dithiocarboxylic acids, sulfenamides, dithiocarbamates, and thiazoles.

17. A golf ball comprising a core and at least one cover layer covering the core, wherein the core is formed of a cured product of a golf ball rubber composition containing (a) a base rubber, (b) an α,β-unsaturated carboxylic acid having 3 to 8 carbon atoms and/or a metal salt thereof as a co-crosslinking agent, and (c) a crosslinking initiator, and an effective crosslinking density DC (mmol/cm³) of the cured product and a tensile modulus TM (MPa) of the cured product at a strain from 0.05% to 0.25% satisfy a relationship of the mathematical formula (1):
TM−333.32×ln(DC)>100 (1).

18. The golf ball according to claim 17, wherein the golf ball rubber composition further contains a hindered phenol-based compound or a hindered amine-based compound as (d) a radical scavenger.

19. The golf ball according to claim 18, wherein the golf ball rubber composition contains (d) the radical scavenger in an amount of 0.5 part by mass or more and 4 parts by mass or less with respect to 100 parts by mass of (a) the base rubber.

20. The golf ball according to claim 17, wherein a ratio (Hs/H75) of a surface hardness (Hs) of the core to a hardness (H75) of the core at a point located at a distance of 75% of a core radius from a center of the core is 0.90 or more and 1.20 or less when the hardness H75 of the core ranges from 70 to 80 in Shore C hardness.
